(19) United States
(12) Patent Application Publication
(10) Pub. No.: US 2008/0275801 A1
(43) Pub. Date: Nov. 6, 2008

(54) METHOD AND SYSTEM FOR INCREASING RETIREMENT INCOME

(76) Inventors: George F. Sanders, South Jordan, UT (US); Michael T. Gunderson, Cottonwood Heights, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/743,602

(22) Filed: May 2, 2007

(51) Int. Cl. G06Q 40/00

(52) U.S. Cl. 705/35

(57) ABSTRACT

A method and system for persons who are over the age of 62 to increase their retirement income by utilizing their insurability and real estate equity to fund the purchase of life insurance and/or annuities which are subsequently gifted to a donor advised fund, a charitable gift annuity, or a combination of both.

### BACKGROUND

1. Field of the Invention

The present invention relates generally to novel systems, methods, plans and products for enabling persons who are over the age of sixty-two to enhance their retirement income. More particularly, it contemplates the purchase, gifting and potential sale of insurance policies to enhance the retirement income of the participant.

The participant must own a personal residence, with or without a mortgage, and be able to access the equity in their residence for the purpose of purchasing one or more life insurance policies on their own life. The policies purchased will, at a later date, be gifted by the owner in whole or in part to a public foundation of their choosing. The donor of the policies will receive a charitable gift annuity (CGA) for a portion or all of the value of the policies which will generate income for the life of the donor. The donor also has the option of donating a part interest or the entire policy to a donor advised fund (DAF). The donor also has the option of retaining a portion of the value of the policy to repay the mortgage. The donor may also split the gift between a CGA and a DAF. The entire process permits flexibility to suit the individualized needs and desires of the insured.

2. Background of the Invention and Related Art

As disclosed in US2004-0199446 A1, it is known that nonprofit institutions including churches, foundations, and charities organize plans to use the unique features of life insurance to fund future liabilities and operations. Examples of such programs are Religious Owned Life Insurance (ROLI), Foundation Owned Life Insurance (FOLI), and Charity Owned Life Insurance (CHOLI). These programs enlist past and/or future donors or benefactors for the purpose of purchasing insurance on a pool of such donors or benefactors. The nonprofit entity may borrow from a bank or possibly the insurance company itself to fund the insurance premiums, and receives death benefits when its donors die. Death benefits are used to repay any loans. The balance of the death benefits, if any, funds the nonprofit entities' primary objectives, such as funding research, furthering religious programs, or disbursing benefits to the needy.

These known insurance plans have revealed a number of unaddressed problems with respect to legal and regulatory issues. Most states have insurance laws requiring the owner of the policy to have an “insurable interest.” That is, there must be a sufficient relationship between the owner of the policy and the insured such that the owner stands to experience a loss should the insured die. Many state laws do not require that the beneficiary of a life insurance policy have an insurable interest. For example, California Insurance Code section 10110.1(b) states that “[a]n individual has an unlimited insurable interest in his or her own life . . . and may lawfully take out a policy of insurance on his or her own life . . . and have the policy made payable to whomsoever he or she pleases, regardless of whether the beneficiary designated has an insurable interest. ”

Some states, however, have additional laws that do restrict the purchase of a policy in some situations. For example, the New York Insurance Laws, section 3205(b)(2) states that “No person shall procure or cause to be procured, directly or by assignment or otherwise any contract of insurance upon the person of another unless the benefits under such contract are payable to the person insured or his personal representatives, or to a person having, at the time when such contract is made, an insurable interest in the person insured.” Some states have carved out exceptions for nonprofit institutions. For example New York Insurance Laws section 3205(b)(3) provides a safe harbor for nonprofit entities which “procure or cause to be procured, directly or by assignment or otherwise, a contract of life insurance upon the person of another and may designate itself or cause to have itself designated as the beneficiary of such contract.”

Despite such exceptions and safe harbor provisions, CHOLI and other nonprofit insurance owned programs still have shortcomings. The returns on these policies are tax free. However, most, if not all, charities which have implemented CHOLI programs have used lenders to provide the funds to purchase the policies. The cost of the funds to the charities can reduce substantially, if not all, of the investment returns to such programs, depending upon the cost of lender funds, the nature of the policies underwritten, and, of course, the mortality experience of the benefactors insured.

Many charities which have utilized CHOLI programs do not have efficient means for selecting an underwriting program of benefactors to achieve superior investment returns on a nominal basis. Such different means would include (1) having access to a well-defined class of insureds with higher mortality risk who happen to be benefactors; (2) underwriting these benefactors with the preferred life insurance products; and (3) financing the underwriting of the insurance efficiently.

Some state insurance regulators disfavor existing CHOLI programs which rely upon private for-profit outside lenders to fund the policies. For example, in May 2002, Michigan regulators denied approval to a plan with such outside investors; the investors “do not have an insurable interest but an investment interest.” (“Dying to Donate: Charities Invest in Death Benefits,” The Wall Street Journal, Feb. 6, 2003).

What is needed is a system which complies with state insurance and non-profit law and which permits qualifying participants to achieve superior, tax-free or tax-reduced return on insurance policies to provide enhanced retirement income.

### SUMMARY OF THE INVENTION

The present invention comprises systems and methods combining insurance policies and tax-free trusts to create a means for generating enhanced retirement income for the participants. The participant is older than sixty-two year of age. The participant has sufficient funds or access to sufficient funds to purchase an insurance policy which will in whole or in part be gifted to a non-profit tax free foundation. The foundation sells the policy in the secondary market. All or part of the proceeds of the sale are directed to a CGA which gives the participant enhanced retirement income for life. Or, all or part of the proceeds of the sale are directed to a DAF to purchase another life insurance policy for the benefit of the DAF.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. is one illustration of an implementation of the proposed system and method for combining insurance and tax-free trusts to enhance retirement income.

### DETAILED DESCRIPTION OF THE PREFERRED EMBODIMENTS

It will be readily understood that the components of the present invention, as generally described and illustrated in the figures herein, could be arranged and designed in a wide variety of different configurations. Thus, the following more detailed description of the embodiments of the system and method of the present invention is not intended to limit the scope of the invention, as claimed, but is merely representative of the presently preferred embodiments of the invention.

The present invention is directed to a program 10 which combines the purchase of insurance with tax-free or tax-reduced trusts and/or gifts. Participants must be at least over sixty-two years of age. Preferably, the participant is seventy-two years of age or older. The age of the participant plays a potentially significant role in the present invention as will be discussed below.

The qualifying participant identifies one or more valuable assets 20 such as savings, equity in a residence, value in an insurance policy, a 1035 exchange or some other asset or personal property. The participant accesses 22 sufficient monetary resources from asset(s) 20. For example, the owner of a personal residence applies for a Reverse Mortgage on their personal residence to have ready access to the equity in the property 22.

Simultaneously the participant applies for a convertible term or universal life insurance policy. The amount of the death benefit of the insurance policy for which the participant qualifies will vary depending on the amount of insurance policy premium the participant can afford. The amount of money available to the participant through a reverse mortgage will depend upon the value of their primary residence, and any existing mortgage balance the participant is obligated to pay back. For example, HUD and FHA place liens on real property in the amount of three times the amount of the loan or the lending limit on the real property in the area where the applicant lives, whichever is less.

The lending limit currently varies from county to county all across the United States.

The amount that can be borrowed on a Reverse Mortgage is the lending limit or the value of the real property whichever is less. Hence, the amount of monetary resources available through a Reverse Mortgage may limit the amount of life insurance the participant may be able to acquire. The participant can qualify for more life insurance coverage if they have other justification for the additional coverage or if the participant has other monetary resources such as savings or any other asset(s).

Once a life insurance policy is approved at an acceptable premium, the Reverse Mortgage is completed and the funds become available. The insurance premium for the first one month up to two years of the life insurance coverage is paid from the Reverse Mortgage proceeds 30 to the insurance company to place the policy in force. If excess funds from the Reverse Mortgage are available, and if desired, a portion of the funds can provide monthly income 24.

To minimize the tax impact and to derive the benefit that was originally sought when the plan was set up, the policy is gifted in part or entirely into a Charitable Gift Annuity (CGA) 40. This is typically done through an Internal Revenue Code 501(c)3 entity. In some states a Charitable Remainder Annuity Trust must be used to achieve the desired result.

Such entities will be referred to as a qualifying legal entity. A portion of the policy may be retained by the owner 42.

After eighteen months, the life insurance policy is shopped for sale in the life settlement market, also known as the secondary market. The policy will sell in the life settlement market 50 for a price determined by the institutions which bid on in-force life insurance policies. The plan works best for persons who are age seventy-two or older at the time of the sale of the policy in the life settlement market. The older the insured is when the policy is sold, the higher the selling price the policy will bring. Health of the insured also is a factor. For example, if the health of the insured deteriorates after the policy is issued, the price paid to purchase the policy in the settlement market will increase because of the possibility of the death benefit being paid sooner.

For example, at age seventy-five, a policy on a male of average health may sell in the secondary market for about twenty-five percent of the life insurance policy death benefit.

Considering that he purchased the policy at age seventy-three for a premium of around $23,000 per year for a $1,000,000 policy, he will realize a substantial gain on the policy; $250,000-$48,000 (principle and interest) for a potential gain of $202,000. A portion of the proceeds can be used to pay off the reverse mortgage loan.

The proceeds of the sale of the policy in the secondary market can then be used by the foundation as agreed or as required. For example, the foundation can direct a portion of the sale proceeds to go to a CGA 52 to guarantee an income stream for the life of the participant donor. The foundation may choose to reinsure the CGA through a commercial insurance company.

The participant's choice to make a gift of the life policy to a foundation 40 that offers Charitable Gift Annuities can thereby avoid capital gains tax and provide a substantial income stream for the donor-participant. In the alternative, the participant may choose to sell the policy outright without gifting it to a foundation and pay the required taxes and take the balance to use as he or she see fit. In either scenario, a portion of the money from the sale could be used to pay off the reverse mortgage against the house, leaving the credit line open for future use by the homeowner.

In a further enhancement, the plan is achieved by gifting the policy to a foundation that will create both a DAF 54 and a CGA 52. This allows the DAF to use a portion of the proceeds from the sale of the policy to purchase another life policy on the advisor/donor 56 using a portion of the sales proceeds that were deposited in the DAF. As the DAF's largest donor, the DAF has an insurable interest in the well being of the donor as the continuing well being of the donor and their fund raising capability is of vital interest to the DAF.

Because this insurable interest exists, the DAF can purchase key-man insurance on the donor. The DAF can then sell that key-man policy in twenty four months in the life settlement market to further enhance the assets of the fund. Further use of this technique would include insuring other members of the board of directors of the DAF who are older than age seventy and in good enough health to qualify for key-man insurance. Each eligible board member over the age of seventy would qualify for a key-man policy owned by the DAF with the DAF as the named beneficiary.

In another alternative embodiment in which the participant cannot qualify for life insurance policy, a similar result can be achieved by taking the proceeds of the reverse mortgage and gifting them to a pass through foundation 40 and placing the proceeds in a CGA funded with an annuity with a separate death benefit. Though a life insurance policy is not available to settle in the secondary market the CGA funded with the proper Annuity with a death benefit to fund the DAF can accomplish a similar result but over a longer period of time.

In another embodiment, the technique can also be used to accomplish the same results by using the surrender value of an existing life insurance policy to create the funds for the premiums on a new policy. This is done by using the IRC section 1035 exchange privilege to fund the first two years of premiums of the new policy. In this technique there is very little possibility of income in the first two years because the funding source is smaller than with the reverse mortgage permitting the participant to only purchase a smaller face value policy. Once the policy is in place the plan works the same as with the reverse mortgage with the exception that there is no option to pay off a loan because no loan exists.

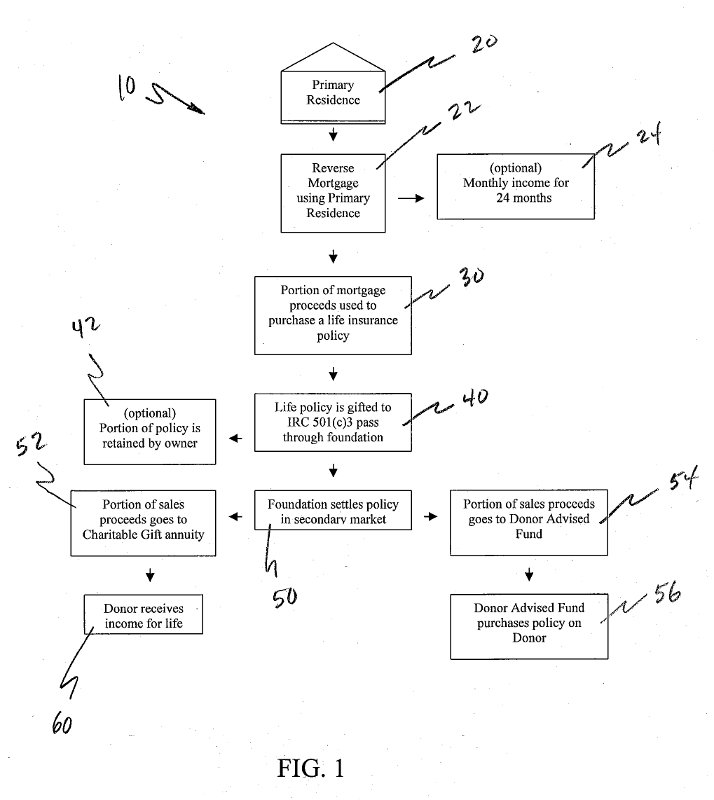

Another embodiment of the program of the present invention is used with persons under the age of seventy. With or without using the reverse mortgage, a large convertible level term insurance policy is purchased with enough years of coverage as a term policy before conversion for the insured to attain the age of seventy-two, or older. The policy is converted to a Universal Life policy and sold. Everything then follows as if the plan had been started at the older age. In all cases, an insurable interest must exist at the time the policy is issued. That is, there must be some legitimate estate planning, family needs, debt repayment, income replacement or other objective. The premium for the term insurance can be fairly low. For example, a forty-five year old preferred risk may be insurable on a thirty year term policy for up to $1,000,000 for an annual premium of approximately $1,000. Such a thirty year convertible term policy would have a cumulative premium of $30,000 by age 75 but the policy would sell in the secondary market for around $250,000 at that age with standard health. In addition the insured has the coverage if there is a premature death or change of health. The proceeds of the sale could then be used to purchase insurance 30 and the rest of the technique of FIG. 1, and the variations discussed above, can be implemented.

While illustrative embodiments have been described above, it will be understood that there is no intent to limit the scope of the inventive systems and methods by such disclosure. The present invention is intended to cover all modifications and alternative arrangements within the spirit and scope of the invention as defined in the following claims.

I claim:

1. A method of providing retirement income, comprising:
acquiring sufficient funds to pay at least one premium on a life insurance policy to insure a person at least seventy-one years of age,
purchasing the insurance policy,
gifting the insurance policy to a qualifying legal entity,
selling of the insurance policy by the qualifying legal entity in the secondary market after at least eighteen months, and
directing at least a portion of the proceeds of the sale of the policy to a charitable gift annuity providing retirement income.

2. The method of claim 1 wherein the step of acquiring sufficient funds comprises funds derived from a reverse mortgage.

3. The method of claim 1 wherein the step of acquiring sufficient funds comprises funds derived from savings.

4. The method of claim 1 wherein the step of acquiring sufficient funds comprises funds derived from the surrender value of an existing life insurance policy through a permissible 1035 exchange.

5. The method of claim 1 wherein the step of purchasing the insurance policy comprises purchasing either a universal life policy or a convertible term life insurance policy.

6. The method of claim 1 further comprising directing at least a portion of the proceeds of the sale of the policy to a donor advised fund.

7. The method of claim 2 further comprising the step of repaying all or part of any reverse mortgage loan from proceeds of the sale of the policy in the secondary market.

8. The method of claim 1 wherein the step of acquiring sufficient funds further comprises acquiring sufficient funds to pay between two and twenty-four premiums on the life insurance policy.

9. A method of providing retirement income, comprising:
acquiring sufficient funds derived from a reverse mortgage to pay at least one premium on a life insurance policy to insure a person at least seventy-one years of age,
purchasing the insurance policy,
gifting the insurance policy to a qualifying legal entity,
selling of the insurance policy by the qualifying legal entity in the secondary market after at least eighteen months, and
directing at least a portion of the proceeds of the sale of the policy to a charitable gift annuity providing retirement income.

10. The method of claim 9 wherein the step of purchasing the insurance policy comprises purchasing either a universal life policy or a convertible term life insurance policy.

11. The method of claim 9 further comprising directing at least a portion of the proceeds of the sale of the policy to a donor advised fund.

12. The method of claim 8 further comprising the step of repaying all or part of any reverse mortgage loan from proceeds of the sale of the policy in the secondary market.

13. The method of claim 9 wherein the step of acquiring sufficient funds further comprises acquiring sufficient funds to pay between two and twenty-four premiums on the life insurance policy.

14. A method of providing retirement income, comprising:
acquiring sufficient funds derived from savings to pay at least one premium on a life insurance policy to insure a person at least seventy-one years of age,
purchasing the insurance policy,
gifting the insurance policy to a qualifying legal entity,
selling of the insurance policy by the qualifying legal entity in the secondary market after at least eighteen months, and
directing at least a portion of the proceeds of the sale of the policy to a charitable gift annuity providing retirement income.

15. The method of claim 14 wherein the step of purchasing the insurance policy comprises purchasing either a universal life policy or a convertible term life insurance policy.

16. The method of claim 14 further comprising directing at least a portion of the proceeds of the sale of the policy to a donor advised fund.

17. The method of claim 14 wherein the step of acquiring sufficient funds further comprises acquiring sufficient funds to pay between two and twenty-four premiums on the life insurance policy.
